(19) United States
(12) Patent Application Publication
(10) Pub. No.: US 2013/0175374 A1
(43) Pub. Date: Jul. 11, 2013

(54) WATER SAVING FOODWASTE DISPOSER SYSTEM

(71) Applicant: Yong Seung Ham, Gyeonggi-do (KR)

(72) Inventor: Yong Seung Ham, Gyeonggi-do (KR)

(21) Appl. No.: 13/825,825

(22) PCT Filed: Sep. 8, 2011
(86) PCT No.: PCT/KR11/06658

§ 371 Date: Mar. 25, 2013

(30) Foreign Application Priority Data
Oct. 8, 2010 (KR) 10-2010-0098226
Sep. 8, 2011 (KR) PCT/KR2011/006658

(51) Int. Cl. B02C 23/22

(52) U.S. Cl. CPC B02C 23/22
USPC 241/46.013

(57) ABSTRACT

A water saving foodwaste disposer system includes: a disposer for crushing foodwaste put therein; a reservoir tank storing service water supplied at ordinary time and simultaneously storing a mixture of water and foodwaste crushed by the disposer; and a circulation pump for providing a power so that the mixture of water and food-waste crushed by the disposer circulates between the disposer and the reservoir tank, wherein the circulation pump is integrally formed with a motor provided to the disposer and is operated by a power of the motor, and wherein the mixture of foodwaste and water is discharged from the reservoir tank. Therefore, it is possible to save water resources such as service water by recycling water, to prevent pipes from being clogged, and to reduce a production cost of a foodwaste disposer system by integrating the circulation pump to the disposer motor.

### TECHNICAL FIELD

This disclosure relates to a water saving foodwaste disposer system, and more particularly, to a water saving foodwaste disposer system for crushing foodwaste and therefore saving water by circulating the foodwaste together with water by means of a disposer, a reservoir tank storing service water supplied at ordinary time, and a circulation pump integrated with a power source of the disposer.

### BACKGROUND ART

Generally, a water transfer method is used to dispose of foodwaste generated at home. In the water transfer method, a disposer is installed to a sink in the kitchen so that the disposer crushes foodwaste put therein and then allows the foodwaste to flow as sewage along a carrying pipe conduit together with a large amount of water. After that, the foodwaste is separated into sludge and water in a septic tank (or, a settling tank) for sewage disposal equipment so that the sludge is collected by a garbage truck and the water is discharged after the sludge treatment. As shown in FIGS. 1 and 2, in the related art, when the crushed foodwaste is discharged, service water is supplied in advance to prevent a discharge pipe from being clogged and ensure the foodwaste and water to be smoothly discharged, and the water should be supplied continuously even the foodwaste is being crushed. In addition, water should be supplied for a period of time even after the foodwaste is completely crushed and discharged. Referring to FIGS. 1 and 2, foodwaste is piled up in a disposer container 100 of the disposer through an input hole 152 of the disposer provided to a sink 50, and a user operates a motor 130 to rotate a grinder 120 in a crushing space 110. At this time, service water is continuously supplied. The grinder 120 crushes the foodwaste into smaller particles by means of rapid rotation, and the crushed foodwaste particles are discharged out through a drainage hole 144 and a drain pipe 142 together with the supplied water and treated as sewage.

As described above, the water transfer method using a general foodwaste disposer treats the crushed foodwaste as sewage together with water while being continuously supplied with service water, and therefore it requires a large amount of service water. This results in more serious dissipation of water resources, which is against the global water-shortage era, and also causes environmental pollution. In addition, this water transfer method does not sufficiently crush foodwaste in many cases to clog the discharge pipe, which causes frequent troubles with the disposer and increases a manufacture cost to provide a high-performance motor or additional device for sufficient crushing.

### DISCLOSURE OF INVENTION

### Technical Problem

This disclosure is directed to providing a water saving foodwaste disposer system which includes a reservoir tank and a disposer connected to the reservoir tank by a series of pipes and may recycle the water of a reservoir tank by circulating the water when a disposer is operating by means of a circulation pump integrated with a motor of the disposer so that the service water supplied at ordinary time at a sink may be recycled.

Therefore, it is possible to save water resources by recycling service water, and it is also possible to prevent a drain pipe from being clogged by decreasing foodwaste particles by means of the circulation treatment. In addition, since the circulation pump is integrated with the motor of the disposer, the recycled water may be supplied at a low cost without a separate pumping power.

### Solution to Problem

In one general aspect, there is provided a water saving foodwaste disposer system, which includes: a disposer for crushing foodwaste put therein; a reservoir tank storing service water supplied at ordinary time and simultaneously storing a mixture of water and foodwaste crushed by the disposer; and a circulation pump for providing a power so that the mixture of water and foodwaste crushed by the disposer circulates between the disposer and the reservoir tank, wherein the circulation pump is integrally formed with a motor provided to the disposer and is operated by a power of the motor, and wherein the mixture of foodwaste and water is discharged from the reservoir tank.

The reservoir tank may include: an overflow discharge pipe for discharging out excessive water sent from the disposer; a flushing discharge valve and a flushing discharge pipe for discharging out the mixture of crushed foodwaste and water; and a circulation pipe for sending the mixture of crushed foodwaste and water to the circulation pump.

### Advantageous Effects of Invention

According to the present disclosure, since the circulation pump is integrated with the motor of the disposer to supply recycled water by means of the circulation pump without demanding a separate pumping power, it is possible to reduce a production cost of the foodwaste disposer system.

In addition, since the water ordinarily used and stored in the reservoir tank is fed again to the disposer whenever the disposer is operated, the water is recycled to save water resources such as service water.

Moreover, since the mixture of foodwaste and water are circulated and crushed to decrease foodwaste particles, the mixture may be easily discharged, and the drain pipe and the foodwaste discharge pipe may be not easily clogged.

### BRIEF DESCRIPTION OF DRAWINGS

The above and other aspects, features and advantages of the disclosed exemplary embodiments will be more apparent from the following detailed description taken in conjunction with the accompanying drawings in which:

FIG. 1 is a schematic view showing a general foodwaste disposer installed to a sink;

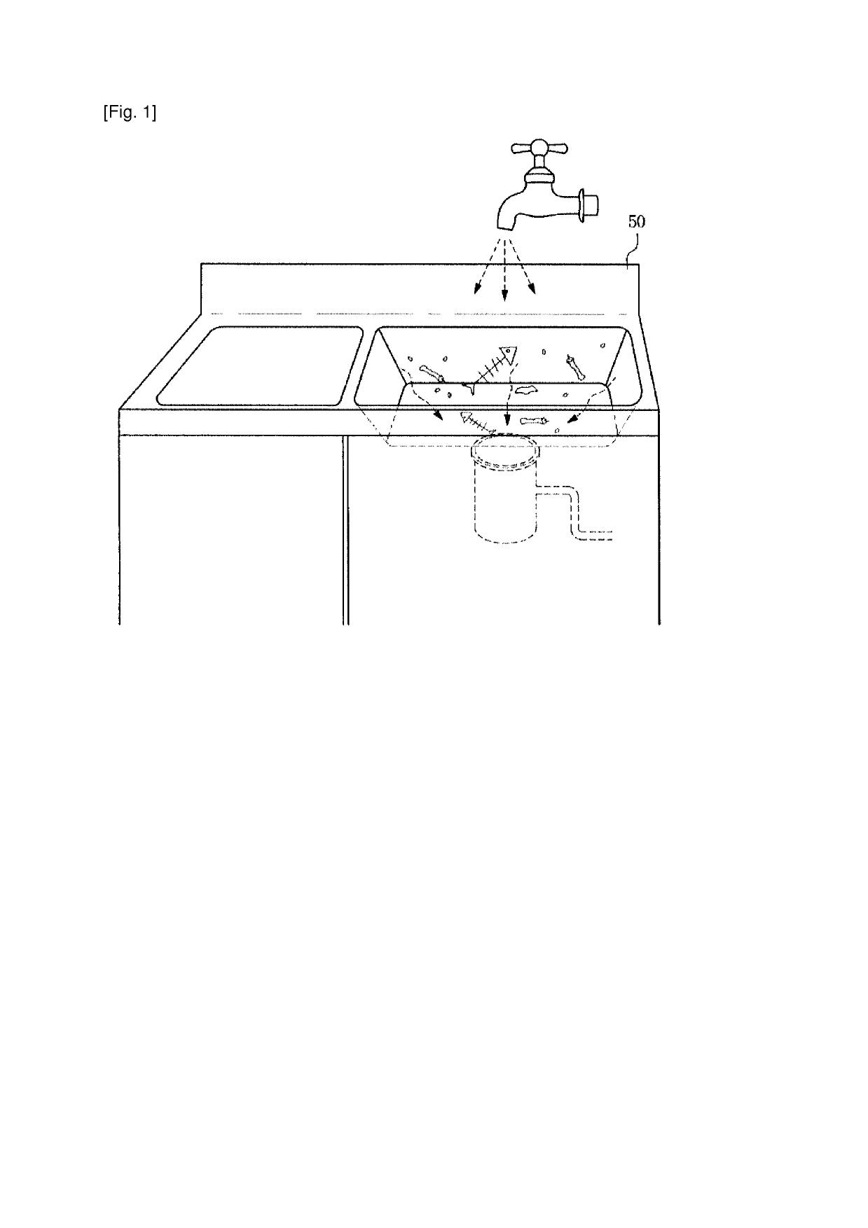

FIG. 2 is a schematic view showing a general foodwaste disposer;

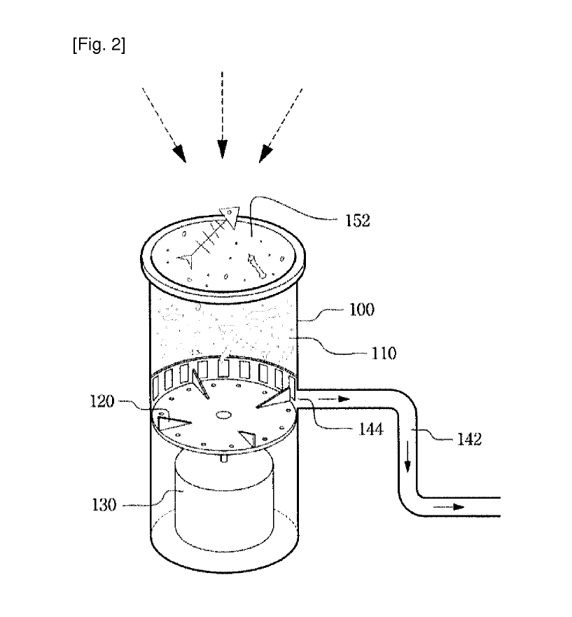

FIG. 3 is a schematic view showing a water saving foodwaste disposer integrated with a circulation pump according to one embodiment of the present disclosure;

FIG. 4 is a schematic view showing a reservoir tank according to one embodiment of the present disclosure; and

FIG. 5 is a schematic view showing a water saving foodwaste disposer system according to one embodiment of the present disclosure.

### BEST MODE FOR CARRYING OUT THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

Hereinafter, the configuration of a water saving foodwaste disposer system according to the present disclosure will be described in detail with reference to the accompanying drawings.

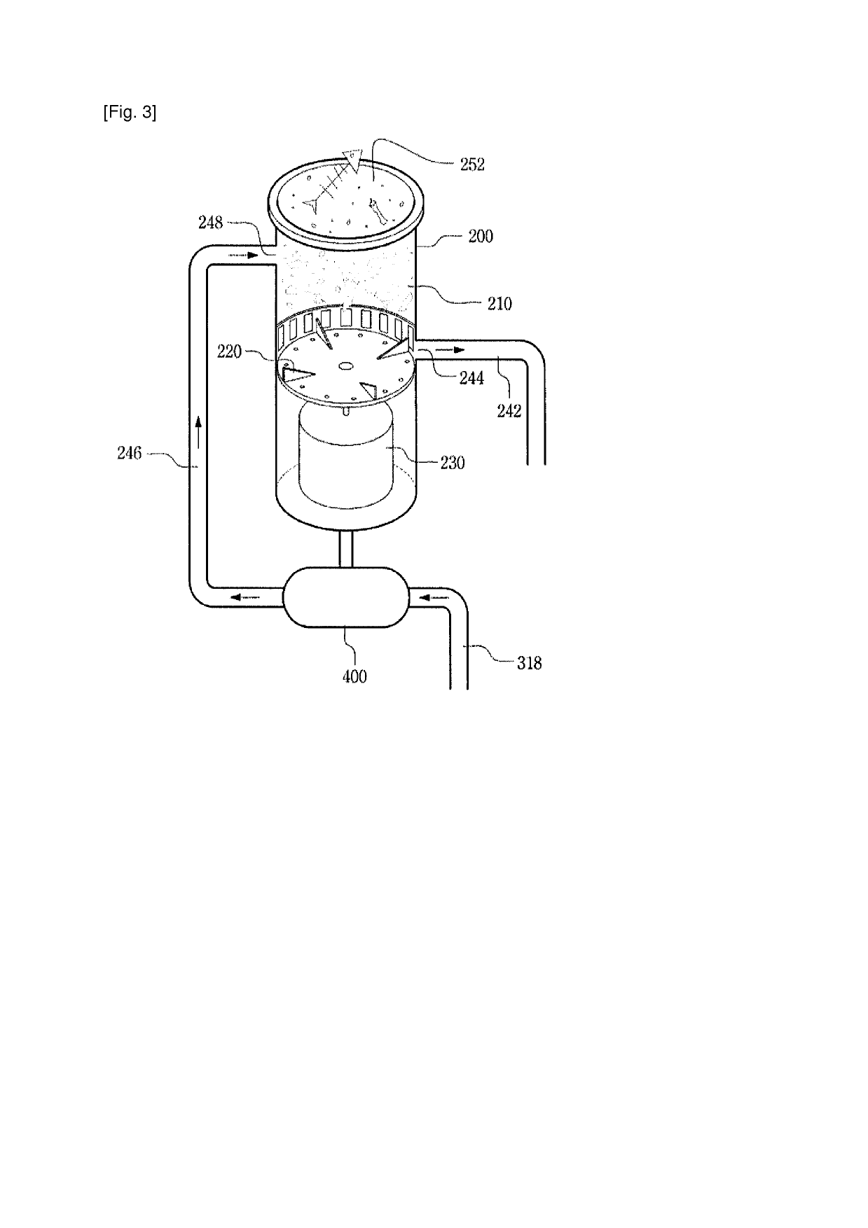

FIG. 3 is a schematic view showing a water saving foodwaste disposer integrated with a circulation pump according to one embodiment of the present disclosure.

Referring to FIG. 3, a disposer 200 includes a disposer container 210, a grinder 220, and a motor 230. The disposer container 210 receives foodwaste and water put through an input hole 252, the grinder 220 rapidly rotate in the disposer container 210 to crush the foodwaste, and the motor 230 is axially connected to the grinder 220 to give a rotating power to the grinder 220. In addition, the motor 230 is axially connected to and integrally formed with a circulation pump 400 provided out of the disposer 200 to give a power to the circulation pump.

The disposer 200 includes a drain pipe 242 for sending the mixture of crushed foodwaste and water to the reservoir tank 300, and a feed pipe 246 for sending the mixture of foodwaste and water from the circulation pump 400 to the disposer container 210.

If water and foodwaste are put through the input hole 252 and accumulated in the disposer container 210 to some extent, a user operates a motor 230 provided to a lower portion in the disposer container 210. By the power of the motor 230, the grinder 220 axially connected to the motor 230 rapidly rotates to crush the foodwaste mixed with water. The mixture of crushed foodwaste and water passes through a drainage hole 244 formed at one side of the disposer container 210 and is discharged through a drain pipe 242. The mixture of discharged foodwaste and water is sent to a reservoir tank 300, explained later. Among the mixture of foodwaste and water sent to the reservoir tank 300, large particles are sent to an external circulation pump 400 axially connected to the motor 230. The circulation pump 400 is supplied with power from the motor 230, and the mixture of foodwaste and water circulates by the circulation pump 400. The circulation pump 400 and the reservoir tank 300 may be connected by a circulation pipe 318. The mixture of foodwaste and water passing through the circulation pump 400 passes a feed pipe 246 and enters the disposer container 210 again through a feed hole 248. The mixture of collected foodwaste and water is crushed again by the grinder 220 and circulates once more along the same path as above.

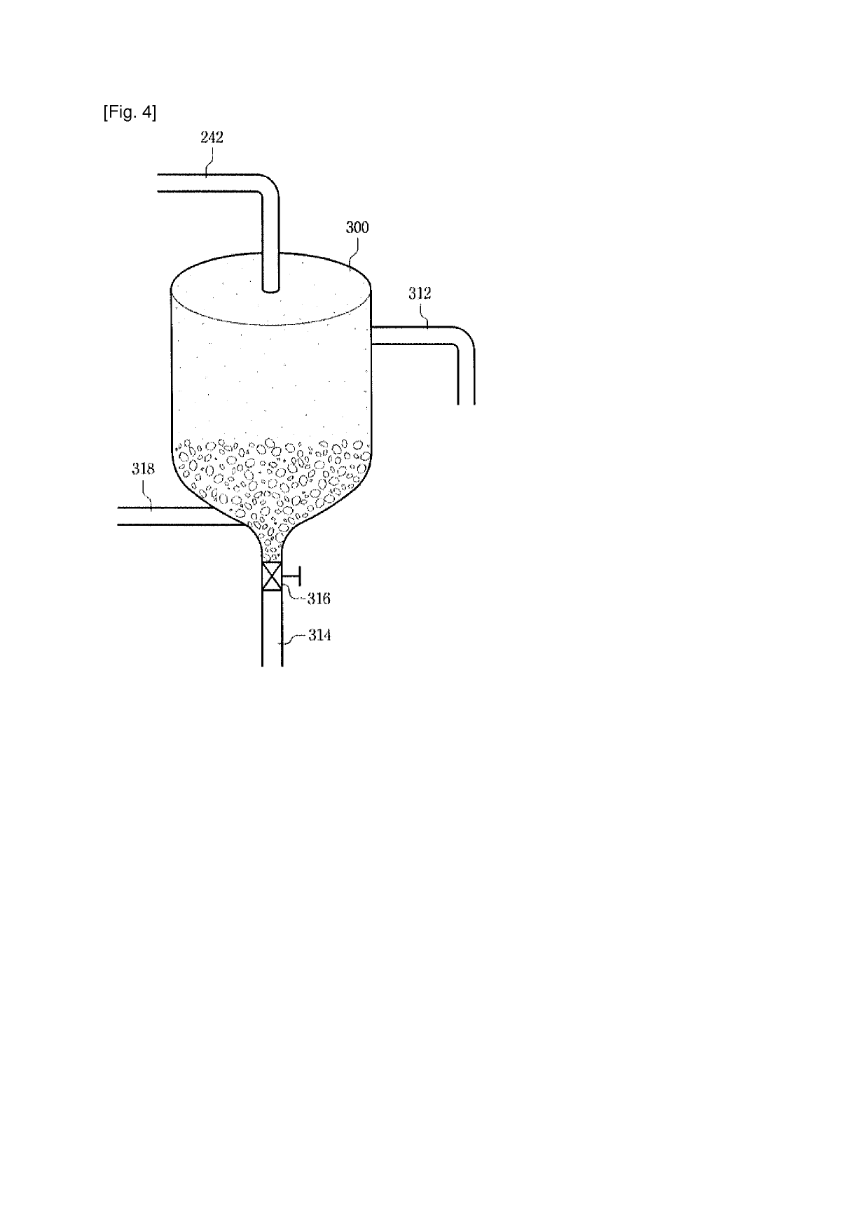

FIG. 4 is a schematic view showing a reservoir tank according to one embodiment of the present disclosure.

Referring to FIG. 4, the reservoir tank 300 includes an overflow discharge pipe 312, a flushing discharge valve 316, a flushing discharge pipe 314, and a circulation pipe 318. The overflow discharge pipe 312 is provided to discharge out excessive water and floating matters supplied from the drain pipe 242 of the disposer 200, and the flushing discharge pipe 314 is provided to discharge out the mixture of crushed foodwaste and water. In addition, the circulation pipe 318 is provided to send the mixture of crushed foodwaste and water put from the reservoir tank 300, to the circulation pump 400. The flushing discharge pipe 314 may be opened or closed by the flushing discharge valve 316.

The mixture of foodwaste and water is sent from the disposer 200 into the reservoir tank 300, and the mixture is crushed into smaller particles due to the circulation between the disposer 200 and the reservoir tank 300. Relatively larger mixture particles are located in the lower portion of the reservoir tank 300, and relatively smaller mixture particles are located in the upper portion of the reservoir tank 300. Since the circulation pipe 318 is provided in the lower portion of the reservoir tank 300, relatively larger mixture particles circulate to the disposer 200 again. Mixture of excessive water and small particles and floating matters are discharged through the overflow discharge pipe 312. If the mixture is sufficiently crushed by the circulation, a user may open the flushing discharge valve 316 so that finely crushed mixture may be discharged out through the flushing discharge pipe 314.

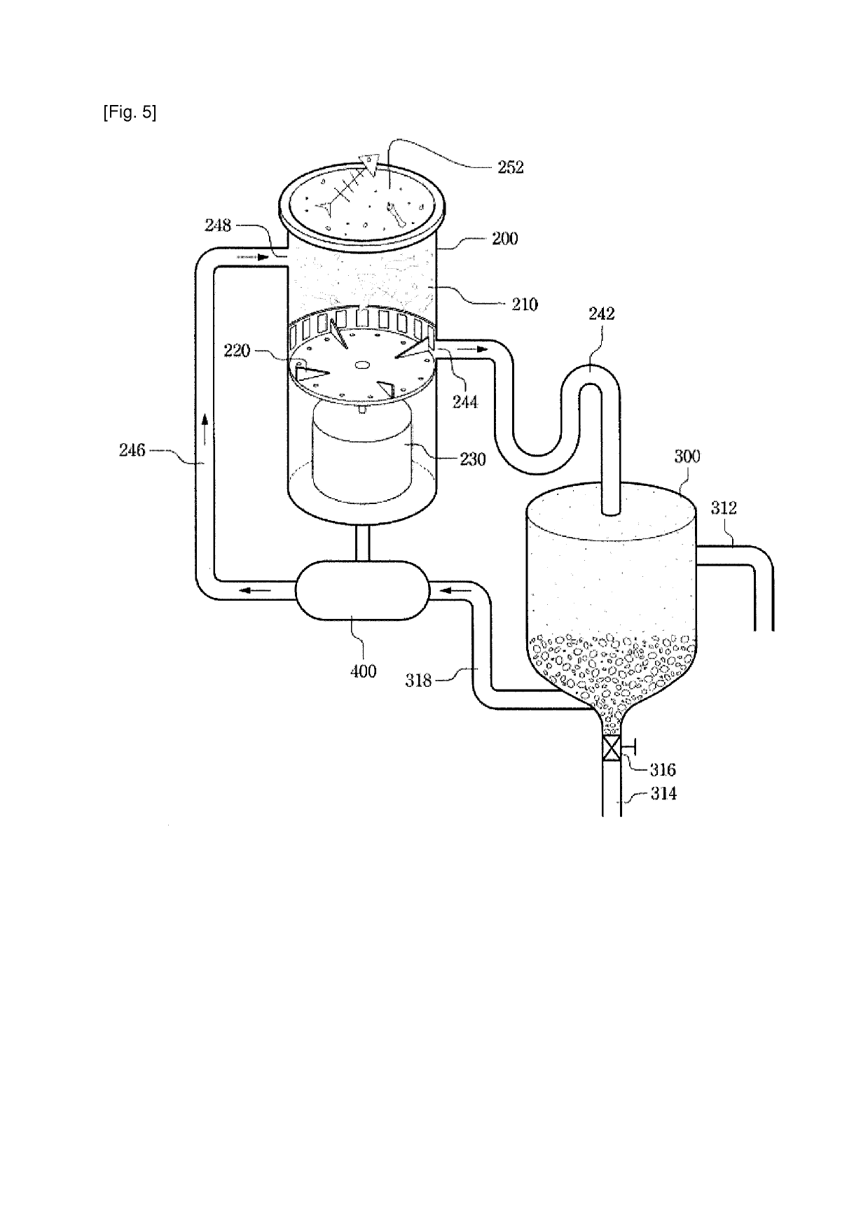

FIG. 5 is a schematic view showing a water saving foodwaste disposer system according to one embodiment of the present disclosure.

Referring to FIG. 5, the foodwaste disposer system includes a disposer 200, a reservoir tank 300, and a circulation pump 400. The disposer 200 crushes foodwaste put through the input hole 252. The reservoir tank 300 gives a space where the mixture of water and foodwaste crushed by the disposer 200 is received. The circulation pump 400 gives a power so that the mixture of water and foodwaste crushed by the disposer 200 circulates between the disposer 200 and the reservoir tank 300.

The disposer 200 includes a disposer container 210, a grinder 220, and a motor 230. The disposer container 210 receives foodwaste and water put through the input hole 252, the grinder 220 rapidly rotates in the disposer container 210 to crush foodwaste, and the motor 230 is axially connected to the grinder 220 to provide a rotating power.

The disposer 200 includes the drain pipe 242 for sending the mixture of crushed foodwaste and water to the reservoir tank 300, and the feed pipe 246 for sending the mixture of foodwaste and water from the circulation pump 400 to the disposer container 210.

The service water, which is ordinarily flowing to a sink, is stored in the reservoir tank 300. Since the reservoir tank 300 has an overflow discharge pipe 312 provided at a certain height to discharge out excessive water, the reservoir tank 300 keeps a consistent water level. Service water is stored in the reservoir tank 300 by sufficient amount to crush foodwaste during dish-washing at the sink. The foodwaste is put through the input hole 252 into the disposer container 210 and gradually accumulated therein. In addition, a user may separately put foodwaste disposer container 210 in order to dispose of the foodwaste. If foodwaste is accumulated to some extent, the user operates the disposer 200. The disposer 200 includes the motor 230 in the lower portion thereof, and the motor 230 may be operated by manipulating a switch. The grinder 220 axially connected to the motor 230 and provided in the disposer container 210 rapidly rotates to crush the foodwaste mixed with water. Meanwhile, the input hole 252 may be closed by a cover so that the mixture of foodwaste and water does not splatters out of the input hole 252 while the disposer 200 performs the crushing operation.

The mixture of crushed foodwaste and water passes through the drainage hole 244 and is sent through the drain pipe 242 to the reservoir tank 300. If the user operates the motor 230, the grinder 220 axially connected thereto rapidly rotates to crush the foodwaste, and simultaneously the circulation pump 400 integrally connected to the motor 230 is operated. The circulation pump 400 provides a power so that the mixture of foodwaste and water may circulates in the disposer system according to the present disclosure. By the operation of the circulation pump 400, the mixture of foodwaste and water is sent from the reservoir tank 300 via the circulation pipe 318 and the feed pipe 246 through the feed hole 248 into the disposer container 210. Since the reservoir tank 300 has the overflow discharge pipe 312, at ordinary time or when the disposer system is operating, the water level is kept up to the height where the overflow discharge pipe 312 of the reservoir tank 300 is formed, and the water above the height is discharged out through the overflow discharge pipe 312. In addition, since the reservoir tank 300 includes the flushing discharge pipe 314, when the foodwaste is crushed into small particles by the circulation of the mixture of foodwaste and water between the disposer 200 and the reservoir tank 300, the user may open the flushing discharge pipe 314 to discharge out the foodwaste. The flushing discharge pipe 314 may be opened or closed by the flushing discharge valve 316. The flushing discharge pipe 314 may be opened or closed by a manual or electric switch. As the crushing process is repeated more and more, smaller mixture particles are circulated and discharged, which further prevents the pipe from being clogged and allows the mixture of foodwaste and water to easily flow. In addition, since the mixture precipitate staying in the reservoir tank 300 for a long time may generate bad smell, the flushing discharge valve 316 provided to the reservoir tank 300 may be opened when the precipitate is discharged, so that the mixture is discharged out through the flushing discharge pipe 314. The valve may be opened or closed by a manual or electric switch.

Meanwhile, at ordinary time or when the disposer system is operating, in order to prevent the foodwaste staying or treated in the drain pipe 242 from generating bad smell or flowing back, as shown in FIG. 5, the drain pipe 242 may have a shape partially convex downwards. In addition, the drain pipe 242 may have a shape repeatedly convex upwards and downwards.

By means of the water saving foodwaste disposer system, it is possible to save water resources by recycling the service water and to prevent the system pipes from being clogged. In addition, since the circulation pump 400 is integrated with the disposer motor 230 to be operated together, a separate driving device is not necessary, which decreases a system production cost.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

### Industrial Applicability

According to the present disclosure, since the circulation pump is integrated with the motor of the disposer to supply recycled water by means of the circulation pump without demanding a separate pumping power, it is possible to reduce a production cost of the foodwaste disposer system.

In addition, since the water ordinarily used and stored in the reservoir tank is fed again to the disposer whenever the disposer is operated, the water is recycled to save water resources such as service water.

Moreover, since the mixture of foodwaste and water are circulated and crushed to decrease foodwaste particles, the mixture may be easily discharged, and the drain pipe and the foodwaste discharge pipe may be not easily clogged.

1. A water saving foodwaste disposer system, comprising:
a disposer for crushing foodwaste put therein;
a reservoir tank storing service water supplied at ordinary time and simultaneously storing a mixture of water and foodwaste crushed by the disposer; and
a circulation pump for providing a power so that the mixture of water and foodwaste crushed by the disposer circulates between the disposer and the reservoir tank,
wherein the circulation pump is integrally formed with a motor provided to the disposer and is operated by a power of the motor, and wherein the mixture of foodwaste and water is discharged from the reservoir tank.

2. The water saving foodwaste disposer system according to claim 1, wherein the reservoir tank includes:
an overflow discharge pipe for discharging out excessive water sent from the disposer;
a flushing discharge valve and a flushing discharge pipe for discharging out the mixture of crushed foodwaste and water; and
a circulation pipe for sending the mixture of crushed foodwaste and water to the circulation pump.
